(19) United States
(12) Patent Application Publication
(10) Pub. No.: US 2014/0287132 A1
(43) Pub. Date: Sep. 25, 2014

(54) Nutritious Snack Mix with Improved Shelf Life

(71) Applicant: I Make Snacks, LLC, Smyrna, GA (US)

(72) Inventors: Christian J. Watson, Prospect Heights, IL (US); Bradley S. Long, Smyrna, GA (US); Heather M. Long, Smyrna, GA (US)

(73) Assignee: I Make Snacks, LLC, Smyrna, GA (US)

(21) Appl. No.: 14/224,011

(22) Filed: Mar. 24, 2014

Related U.S. Application Data
(60) Provisional application No. 61/804,642, filed on Mar. 23, 2013.

(51) Int. Cl. A23L 1/212; A23L 1/317; A23L 1/36; B65B 25/00; B65D 30/08

(52) U.S. Cl. CPC A23L 1/2123; B65B 25/001; B65D 31/04; A23L 1/362; A23L 1/317
USPC 426/632; 426/629

(57) ABSTRACT

Nutritious snack or trail mix compositions, each having a stable moisture content and improved shelf life, and representing a variety of ingredient mixtures and flavors derived from pre-determined blend of meat jerky, raw nuts/sprouted nuts/seeds, and dried fruits is disclosed. Methods of preparing and packaging such nutritious snack or trail mix compositions are also disclosed.

### CROSS REFERENCE TO RELATED APPLICATIONS

This patent application claims priority benefit under 35 U.S.C. §119(e) of U.S. Prov. Pat. Appl. No. 61/804,642, entitled “Nutritious Snack Mix with Improved Shelf Life and Method of Preparing the Same,” filed Mar. 23, 2013, which is incorporated herein by reference in its entirety.

### FIELD OF THE INVENTION

The present invention relates generally to prepared foods and, more particularly, to nutritious snack or trail mix compositions, each having an improved shelf life, the compositions representing a variety of ingredient mixtures and flavors derived from pre-selected blends of meat jerky, raw nuts/sprouted nuts/seeds, and dried fruits and methods of preparing and packaging the same.

### BACKGROUND OF THE INVENTION

It is common for snacks to be convenient and tasty but unhealthy, like chocolate candy bars, potato chips, pretzels, peanut butter crackers, cookies, and the like.

Although traditional snacks are appealing in taste and convenience, they have a negative impact on the physical and mental health of consumers. In particular, it is generally acknowledged that high fat, high salt, high calorie, and low dietary fiber levels in traditional snack foods contribute to obesity and to many chronic diseases, such as diabetes, high blood pressure, heart disease, stroke, and certain types of cancer.

Although most consumers know the health drawbacks and long term risks associated with junk foods and unhealthy snacks, it is much easier to turn to junk food because they are pre-packaged, have a long shelf life and are generally convenient. Junk foods also provide short-term pleasure because of their high salt, sugar, and fat content. Healthy snacks tend to be less convenient, often have to be prepared by the consumer, and often contain perishable products, such as fruits and vegetables, which have a short shelf life. Further, nutritious or healthy snacks, such as conventional “health foods,” may be a more convenient to prepare or to buy in pre-packaged form, but are often lacking in taste, flavor, or texture.

Some consumers turn to high protein or high energy candy bars, prepared drinks, or drink mixes but, due to the undesirable flavor, texture, or appearance of such products, selection and use of these products tends to be short-lived and consumers often drift back to consuming traditional, but less healthy, snack foods. In addition, high protein or high energy drinks are often not suitable or convenient for taking “on-the-go” or “on the trail” since such drinks, to be palatable, usually must be kept cold and/or consumed fairly quickly if prepared by the consumer using a mix. Similarly, high protein or high energy candy bars are often not suitable or convenient for taking “on-the-go” or “on the trail” since they tend to melt or break down in hot environments. Dry snack mixes, such as granola packs or bars, that can be taken “on-the-go” tend to have a short shelf life and must be eaten within a few days of preparation, are one dimensional in content, flavor, and nutritional value, or tend not to be high in healthy nutritional value.

Given the aforementioned deficiencies of existing snack foods in the industry, there is a need for a snack or trail mix that combines meat products with fruits and nuts and that has a stable moisture content. There is a further need for creating stasis in the snack packaging used for healthy snack mixes that can absorb excess oxygen within the snack package that contains such snack mixes. Controlling the moisture content and absorbing excess oxygen further has the advantage of not only improving the shelf life of snack mixes but also maintaining the quality, appearance, and taste of such snack mixes for a longer period of time. There is a further need for snack or trail mixes that come in a variety of desired flavors and combinations of ingredients.

More specifically, there is a need for a snack or trail mix that combines meat jerky with nuts, seeds, and/or fruit, that uses non-genetically modified (non-GMO) ingredients, that is gluten-free, that uses hormone-free proteins, that uses unsulfured fruits, and that does not use artificial preservatives, but still has a shelf life of 8-12 months once packaged, and that maintains the quality, appearance, and taste of such snack mixes for the duration of its shelf life.

### SUMMARY OF EMBODIMENTS OF THE INVENTION

The present invention relates generally to prepared foods and, more particularly, to nutritious snack or trail mix compositions, each having an improved shelf life, the compositions representing a variety of ingredient mixtures and flavors derived from a desired blend of meat jerky, raw nuts/sprouted nuts/seeds, and dried fruits. The present invention also relates to methods of preparing and packaging such nutritious snack mix compositions.

One aspect of the present inventions is directed to creating a snack or trail mix that combines meat products with fruits and nuts and that has a stable moisture content. A second aspect of the present inventions is directed to creating stasis in the snack packaging to absorb excess oxygen within the snack package that contains the snack mix. The snack mix preferably comes in a variety of desired flavors and combinations. Controlling the moisture content and absorbing excess oxygen further improves the shelf life and longer-term taste of the snack mix.

In one embodiment, a desired snack food or trail mix is created by combining: preserved meat products (jerky), dried fruits, and raw and sprouted nuts (to include seeds). Best performing fruits are those with low moisture and less exposed cut surface area (raisins, cranberries, cherries, etc.). Maintaining such a mix in stasis, to provide longer shelf life, is desired and accomplished by controlling moisture content of the mix in the snack package and by use of an appropriately sized oxygen-inhibitor sachet (or packet), sized based on the quantity of mixture and based on the dimensions of the snack package.

Testing has shown that these components or ingredients specifically work together because the moisture transfer does not impair the integrity of each ingredient when they are packaged together. The meat protein slices are diced (preferably by the manufacturer or close to re-packaging) to release excess moisture and to create a more palatable texture to the product. It is desirable to prepare and cut the jerky to recipe specifications in advance and pack such jerky under stasis in a “ready to mix” interim packaging. The jerky can then be introduced at the end of the trail mix packing process to minimize the amount of oxygen exposure. The diced meat net weight preferably represent no more than 40% of the overall recipe net weight to inhibit and minimize the amount of moisture transfer to the other ingredients. Next dried fruits (predetermined by size per each recipe) and nuts (to include seeds) are mixed together in a batch recipe and introduced in the final, commercial pouch/packaging that will hold the entire snack mixture. Preferably, the combined nuts and dried fruit represent 60% or greater of the total net weight of the final trail mix.

The components of this trail mix represent “ready-to-eat” products. Nuts may include raw or sprouted nuts, both flavored and unflavored. This mix has been successful with heartier raw nuts, such as almonds, macadamia, walnuts, pecans, and cashews. Meat proteins (jerky) may include sources of beef, pork, elk, venison, turkey, ostrich, and other low moisture jerky products varying in flavor and spices. Most dried fruit products appear to work well with this mixture, as long as fruits with high water activity or content are excluded. Best performing fruits appear to be raisins, cranberries, cherries, and the like. Some stone fruit, such as nectarines or peaches, also appear to work well when diced and sufficiently dried.

From a production and packaging standpoint, batch recipes of dried fruit and nuts (with a desired combination of flavors and portions selected based on the specific meat protein that will be added to this specific combination of fruits and nuts) are preferably mixed concurrently, so that total exposure time of the overall mixture to air or normal atmospheric conditions can be limited. Then the pre-prepared jerky can be open from its interim, air-tight packaging and mixed with the fruit and nut mixture and then processed to packing instruction.

In one embodiment, the following processing steps are taken: (i) ingredients are pulled to meet the ratios of the recipe being prepared; (ii) the ingredients are inspected to ensure that none of the seals have been broken for ingredients that were in interim air tight packaging and to ensure that such ingredients are in good condition and not damaged, tainted, or spoiled; (iii) fruit and nut/seed mixtures are prepared and combined and any large chunks or clumps of product are broken up; (iv) pre-cut jerky meat protein is removed from its interim, air-tight packaging (if obtained from a meat-jerky supplier) and checked for quality; any large pieces of jerky are identified and processed into smaller pieces, if necessary; preferably, a “timer” is set to verify and ensure that the time of exposure of the jerky to atmospheric conditions is limited to no more than 12 hours (with a max exposure of 16 hours) without a return to stasis; (v) each set of ingredients of the snack or trail mix are then processed by an automated packing line in which predetermined amounts of ingredients are added to individual snack packages/pouches, a moisture-absorbing sachet is inserted into the individual snack packages/pouches, excess air is removed from the individual snack packages/pouches, individual snack packages/pouches are heat sealed and code dated, and the sealed individual snack packages/pouches are examined for quality control purposes to ensure no tears, holes, rips, etc. (NOTE: small batches of product can be packed by hand using the same process described above as being automated); in some embodiments, pouches are formally inspected for quality control using hazards analysis and critical control points (HACCP) procedures.

In preferred embodiments, the process further includes the steps of (vi) boxing together individual snack packages/pouches in larger quantities according to case count in corrugate and sealed; and (vii) finished corrugate cases are packed on pallets for shipping.

In another embodiment, in which jerky is initial processed or provided in larger sizes, the following processing steps are taken: (i) meat protein is removed from its original stasis pouch (from supplier) and checked for quality; a “timer” is set to verify and ensure that the time of exposure is limited to no more than 12 hours (with a max exposure of 16 hours) without a return to stasis. Preferably, the processing and mixing of the dried fruits and nuts/seeds are handled concurrently to limit the exposure of all ingredients to air before the combined mix is returned to stasis; (ii) the jerky strips are processed through a cutter and then quickly checked again for quality—removing any unusable pieces and identifying and then processing any large pieces of jerky into smaller pieces, if necessary; (iii) the meat protein and an oxygen absorbing sachet (or packet) are then inserted into the final, commercial snack package/pouch; (iv)then, an additive (such as flavoring or seasoning) can also be included within the snack package—depending on the selected recipe of the end product; (v) the dried fruit and nut/seed ingredients are then added to the snack package to complete the desired net weight for the snack package; (vi) excess air is removed from the individual snack packages/pouches, individual snack packages/pouches are heat sealed and code dated, and the sealed individual snack packages/pouches are examined for quality control purposes to ensure no tears, holes, rips, etc. (NOTE: small batches of product can be packed by hand using the same process described above as being automated); in some embodiments, pouches are formally inspected for quality control using hazards analysis and critical control points (HACCP) procedures.

In preferred embodiments, the process further includes the steps of (vii) boxing together individual snack packages/pouches in larger quantities according to case count in corrugate and sealed; and (viii) finished corrugate cases are packed on pallets for shipping.

In preferred embodiments, as the net weight of the mixture increases, so does the size of the sachet. The total volume of the pouch will determine the size of the sachet to maintain stasis. Also, the dimensions of the snack package are used to determine the appropriate size sachet. The material used to make the snack packages are preferably selected from EVOH, Metalized, or Foil material—based on their oxygen transfer rate (OTR).

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a flow chart of the processing and packaging steps for making a trail mix according to one embodiment of the present invention;

FIG. 2 illustrates a flow chart of the processing and packaging steps for making a trail mix according to another embodiment of the present invention;;

FIG. 3 shows a first exemplary recipe of a trail mix according to embodiments of the present invention;

FIG. 4 shows a second exemplary recipe of a trail mix according to embodiments of the present invention;

FIG. 5 shows a third exemplary recipe of a trail mix according to embodiments of the present invention; and

FIG. 6 shows a fourth exemplary recipe of a trail mix according to embodiments of the present invention.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In a preferred embodiment, a desired snack food is created by combining: preserved meat products (jerky), dried fruits, and raw and sprouted nuts (to include seeds). From testing data, it has been determined that the best performing fruits are those with low moisture and less exposed cut surface area, such as raisins, cranberries, cherries, and the like. Maintaining such a snack mix in stasis, to provide longer shelf life, is desired and accomplished by controlling moisture content of the mix in the snack packaging and by use of an appropriately-sized oxygen-inhibitor sachet (or packet), sized based on the quantity of mixture and based on the dimensions of the snack packaging.

Testing has shown that these components or ingredients of preserved meat products (jerky), dried fruits, and raw and sprouted nuts (to include seeds) specifically work well together because the moisture transfer between them does not impair the integrity of each individual ingredient when they are packaged together. Dried fruits (predetermined by size per the recipe for each specific snack mix composition) and raw or sprouted nuts (to include seeds) are mixed together in a batch recipe and introduced into commercial packaging (in the form of a pouch) that will ultimately hold the entire snack mixture. Preferably, the combined nuts and fruit represent 60% or greater of the overall recipe total net weight for each composition.

The meat protein is diced (preferably by the manufacturer or close to re-packaging) to release some moisture and to create a more palatable texture for the desired end product. Preferably, the meat protein is in the form of preserved meat, such as “jerky,” that can be prepared in advance and sealed under statis, until ready for final mixing, in “ready to mix” interim packaging. The jerky can then be removed from its interim packaging and added to the final snack mix product (i.e., the pouch that already contains the combination of dried fruit and nuts/seeds) at the end of the snack mix packaging process to minimize, to the greatest extent possible, the amount of oxygen to which the jerky is exposed during the snack mix packaging process. The diced jerky preferably represents no more than 40% of the overall recipe total net weight for any particular composition of snack mix, which helps to inhibit and minimize the amount of moisture transfer from the jerky to the other ingredients of each respective snack mix composition.

The components of the variety of snack mix compositions described in greater detail herein represent “ready-to-eat” products. Nuts preferably include raw and sprouted nuts, and can be either flavored or unflavored. Test data has shown that the snack mix compositions described herein work well with heartier raw nut varieties, such as almonds, macadamia, walnuts, pecans, and cashews.

Meat proteins (i.e., jerky) preferably come from many different sources, including beef, pork, elk, venison, turkey, ostrich, and other low moisture jerky products. Such jerky products can be combined with a wide variety of flavoring, seasoning, preparation type (dried, smoked, etc.), and spices.

Most dried fruit products appear to work well with the snack mixture compositions described herein, as long as fruits with high water activity or content are excluded. From testing, it has been determined that the best performing fruits are those with low moisture and less exposed cut surface area, such as raisins, cranberries, cherries, and the like. In addition, some stone fruits, such as such as nectarines and peaches, have been shown to work well in small diced sizes, when dried sufficiently.

From a production and packaging standpoint, batch recipes of dried fruit and nuts (with a desired combination of flavors and portions selected based on the specific meat protein that will be added to this specific combination of fruits and nuts) are preferably mixed concurrently, so that total exposure time of the overall mixture to air or normal atmospheric conditions can be limited. Then the pre-prepared jerky can be open from its interim, air-tight packaging and mixed with the fruit and nut mixture and then processed to packing instruction.

In one embodiment, the following processing steps are taken: (i) ingredients are pulled to meet the ratios of the recipe being prepared; (ii) the ingredients are inspected to ensure that none of the seals have been broken for ingredients that were in interim air tight packaging and to ensure that such ingredients are in good condition and not damaged, tainted, or spoiled; (iii) fruit and nut/seed mixtures are prepared and combined and any large chunks or clumps of product are broken up; (iv) pre-cut jerky meat protein is removed from its interim, air-tight packaging (if obtained from a meat-jerky supplier) and checked for quality; any large pieces of jerky are identified and processed into smaller pieces, if necessary; preferably, a “timer” is set to verify and ensure that the time of exposure of the jerky to atmospheric conditions is limited to no more than 12 hours (with a max exposure of 16 hours) without a return to stasis; (v) each set of ingredients of the snack or trail mix are then processed by an automated packing line in which predetermined amounts of ingredients are added to individual snack packages/pouches, a moisture-absorbing sachet is inserted into the individual snack packages/pouches, excess air is removed from the individual snack packages/pouches, individual snack packages/pouches are heat sealed and code dated, and the sealed individual snack packages/pouches are examined for quality control purposes to ensure no tears, holes, rips, etc. (NOTE: small batches of product can be packed by hand using the same process described above as being automated); in some embodiments, pouches are formally inspected for quality control using hazards analysis and critical control points (HACCP) procedures.

In preferred embodiments, the process further includes the steps of (vi) boxing together individual snack packages/pouches in larger quantities according to case count in corrugate and sealed; and (vii) finished corrugate cases are packed on pallets for shipping.

In another embodiment, in which jerky is initial processed or provided in larger sizes, the following processing steps are taken: (i) meat protein is removed from its original stasis pouch (from supplier) and checked for quality; a “timer” is set to verify and ensure that the time of exposure is limited to no more than 12 hours (with a max exposure of 16 hours) without a return to stasis. Preferably, the processing and mixing of the dried fruits and nuts/seeds are handled concurrently to limit the exposure of all ingredients to air before the combined mix is returned to stasis; (ii) the jerky strips are processed through a cutter and then quickly checked again for quality—removing any unusable pieces and identifying and then processing any large pieces of jerky into smaller pieces, if necessary; (iii) the meat protein and an oxygen absorbing sachet (or packet) are then inserted into the final, commercial snack package/pouch; (iv)then, an additive (such as flavoring or seasoning) can also be included within the snack package—depending on the selected recipe of the end product; (v) the dried fruit and nut/seed ingredients are then added to the snack package to complete the desired net weight for the snack package; (vi) excess air is removed from the individual snack packages/pouches, individual snack packages/pouches are heat sealed and code dated, and the sealed individual snack packages/pouches are examined for quality control purposes to ensure no tears, holes, rips, etc. (NOTE: small batches of product can be packed by hand using the same process described above as being automated); in some embodiments, pouches are formally inspected for quality control using hazards analysis and critical control points (HACCP) procedures.

In preferred embodiments, the process further includes the steps of (vii) boxing together individual snack packages/pouches in larger quantities according to case count in corrugate and sealed; and (viii) finished corrugate cases are packed on pallets for shipping.

In preferred embodiments, as the net weight of the mixture increases, so does the size of the sachet. The total volume of the pouch will determine the size of the sachet to maintain stasis. Also, the dimensions of the snack package are used to determine the appropriate size sachet. The material used to make the snack packages are preferably selected from EVOH, Metalized, or Foil material—based on their oxygen transfer rate (OTR).

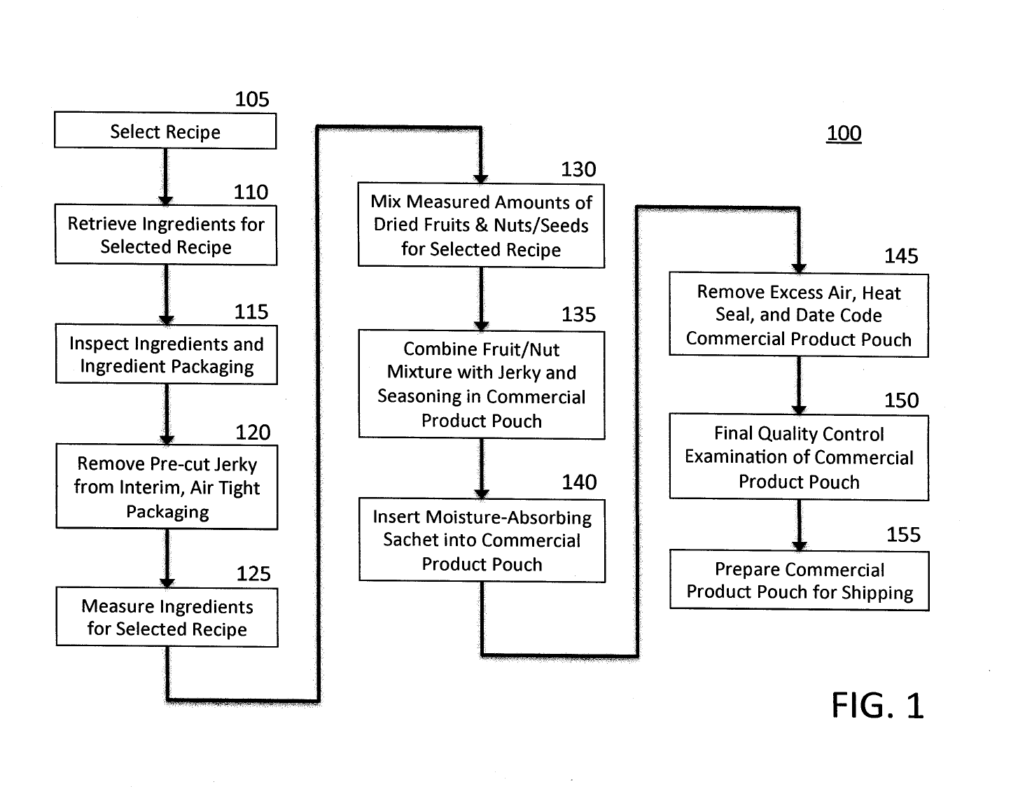

Turning now to FIG. 1, a flow chart 100 of the processing and packaging steps for making a nutritious snack or trail mix composition according to one embodiment of the present invention is illustrated. Initially, a batch recipe with a desired combination of flavors, seasoning, and portions selected for the specific meat jerky, fruits, nuts/seeds associated with that recipe is chosen (Step 105). The relevant ingredients for the selected recipe are then retrieved for further processing and handling (Step 110). Preferably, the relevant ingredients are then inspected, both the ingredients themselves as well as any packaging from which the ingredients were retrieved to ensure that such ingredients are in good condition and not damaged, tainted, or spoiled (Step 115).

Pre-cut jerky meat protein is removed from its interim, air-tight packaging (if obtained from a meat jerky supplier) and checked for quality (Step 120). As part of this step, any large pieces of jerky are identified and processed into smaller pieces, if necessary. Further, a “timer” is set and used to ensure that the exposure of the jerky to atmospheric conditions is preferably limited to under 12 hours (with a max exposure of 16 hours) without a return to stasis. All of the ingredients are then measured out to desired portions, based on the desired ratios for the selected recipe (Step 125). Next, the fruit and nut/seed mixtures, at the specified ratios, are combined and any large chunks or clumps of product are broken up (Step 130).

Each set of ingredients of the snack or trail mix associated with the selected recipe are then processed, preferably by an automated packing line but in some embodiments, by hand, in which the measured amounts of each ingredient are added to individual snack packages/pouches (Step 135). A moisture-absorbing sachet is inserted into the individual snack packages/pouches (Step 140). Any excess air is removed to desired levels (ranging between vacuum packing and less compressed packing) to from the individual snack packages/pouches, individual snack packages/pouches are heat sealed, and then code dated (Step 145). Preferably, the snack packages/pouches already have suitable labeling and design elements printed or contained on the outer surface of the packages/pouches. Next, the sealed individual snack packages/pouches are subjected to one or more levels of examination for quality control purposes to ensure that there are no tears, holes, rips, or other defects in the sealed individual snack packages/pouches (Step 150). In some embodiments, the one or more levels of examination for quality control purposes include formal inspections using hazards analysis and critical control points (HACCP) procedures used in the food processing industry.

Finally, the process 100 further includes the steps of preparing the sealed individual snack packages/pouches for shipping (Step 155). In some embodiments, such preparation includes boxing together individual snack packages/pouches in larger quantities according to case count in corrugate, which is then sealed; and then packing such sealed corrugate cases onto pallets for shipping.

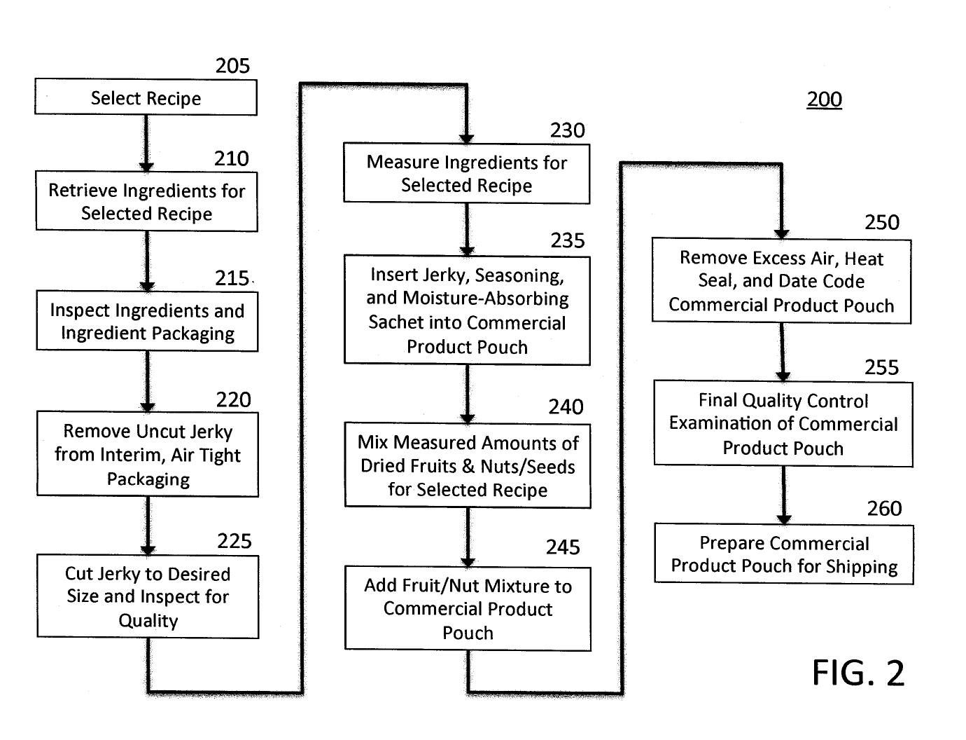

Turning now to FIG. 2, a flow chart 200 of the processing and packaging steps for making a nutritious snack or trail mix composition according to another embodiment of the present invention is illustrated. Initially, a batch recipe with a desired combination of flavors, seasoning, and portions selected for the specific meat jerky, fruits, nuts/seeds associated with that recipe is chosen (Step 205). The relevant ingredients for the selected recipe are then retrieved for further processing and handling (Step 210). Preferably, the relevant ingredients are then inspected, both the ingredients themselves as well as any packaging from which the ingredients were retrieved to ensure that such ingredients are in good condition and not damaged, tainted, or spoiled (Step 215).

Next, uncut jerky meat protein is either provided directly from a meat jerky production line or, if prepared in advance or prepared at a different production facility, such as a meat jerky supplier, removed from an interim, air-tight packaging and checked for quality (Step 220). After cutting, any large pieces of jerky are identified, checked for quality again, and processed into smaller pieces, as necessary (Step 225). As part of the above steps, a “timer” is set and used to ensure that the exposure of the jerky to atmospheric conditions is preferably limited to under 12 hours (with a max exposure of 16 hours) without a return to stasis. All of the ingredients are then measured out to desired portions, based on the desired ratios for the selected recipe (Step 230).

Next, the meat protein (i.e., cut jerky) and an oxygen absorbing sachet (or packet) are inserted into the final, commercial snack package/pouch (Step 235). As part of this step, an additive (such as flavoring or seasoning) can also be included within the snack package—depending on the selected recipe of the end product.

Next, the fruit and nut/seed mixtures, at the specified ratios, are combined and any large chunks or clumps of product are broken up (Step 240). The dried fruit and nut/seed ingredients are then added to the snack package to complete the desired net weight for the snack package (Step 245). Each set of ingredients of the snack or trail mix associated with the selected recipe are inserted into the snack packages (in the above steps), preferably by an automated packing line but in some embodiments, by hand.

Next, any excess air is removed to desired levels (ranging between vacuum packing and less compressed packing) to from the individual snack packages/pouches, individual snack packages/pouches are heat sealed, and then code dated (Step 250). Preferably, the snack packages/pouches already have suitable labeling and design elements printed or contained on the outer surface of the packages/pouches. Next, the sealed individual snack packages/pouches are subjected to one or more levels of examination for quality control purposes to ensure that there are no tears, holes, rips, or other defects in the sealed individual snack packages/pouches (Step 255). In some embodiments, the one or more levels of examination for quality control purposes include formal inspections using hazards analysis and critical control points (HACCP) procedures used in the food processing industry.

Finally, the process 200 further includes the steps of preparing the sealed individual snack packages/pouches for shipping (Step 260). In some embodiments, such preparation includes boxing together individual snack packages/pouches in larger quantities according to case count in corrugate, which is then sealed; and then packing such sealed corrugate cases onto pallets for shipping.

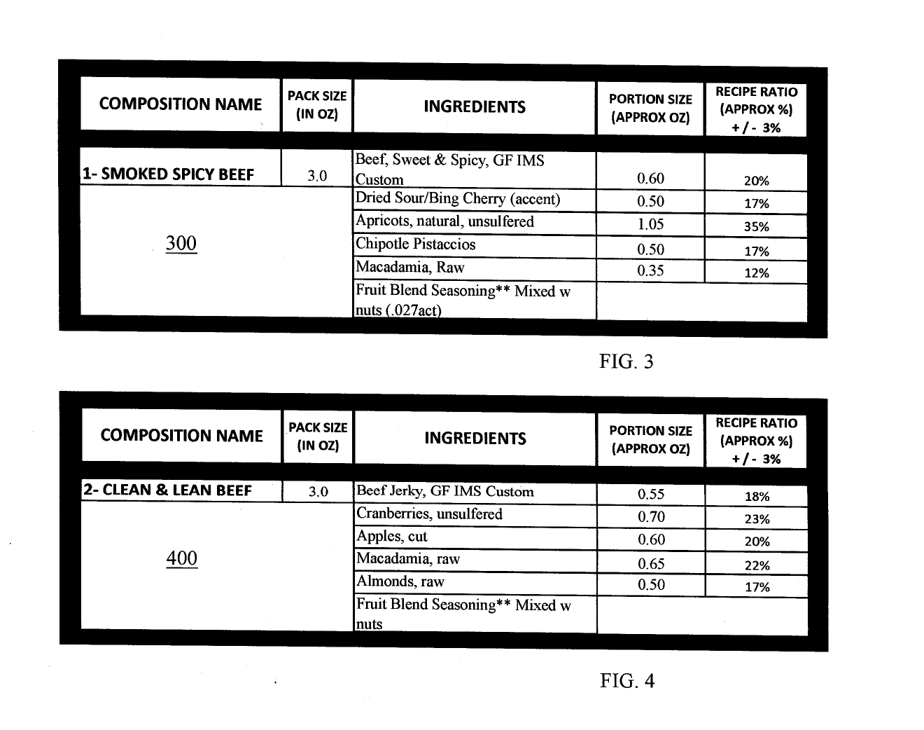

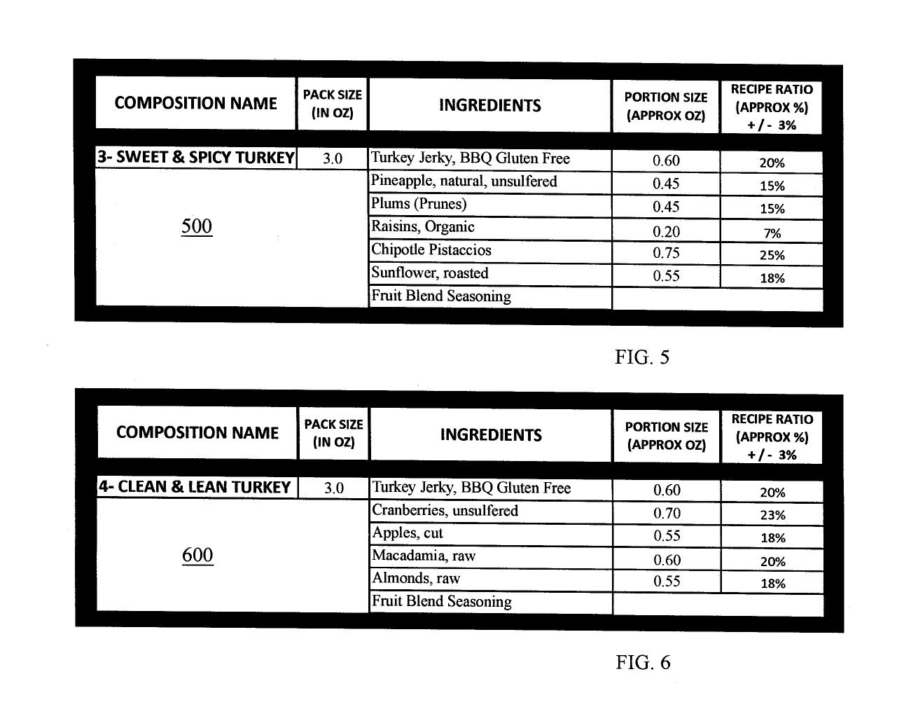

Turning now to FIGS. 3-6, several exemplary recipes for a variety of snack/trail mix compositions 300, 400, 500, and 600, respectively, are illustrated. Each composition is given a suitable name. The recipes are shown for packaging/pouch sizes of 3 ounces (oz.). Each of the base ingredients are listed, along with the desired quantity of each ingredient shown in ounces (oz.) and approximate percentage of each ingredient included in the recipe and included in the product packaging/pouch. The desired quantity and percentage ratios are approximate, but are indicative of the amounts of each ingredient relative to the other ingredients.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be appreciated that the Detailed Description section, and not the Summary and Abstract sections, is intended to be used to interpret the claims. The Summary and Abstract sections may set forth one or more, but not all, exemplary embodiments of the present invention as contemplated by the inventor(s), and thus, are not intended to limit the present invention and the appended claims in any way.

What is claimed is:

1. A process for assembling and creating a nutritious snack mix composition having a desired combination of flavors, seasoning, and portions, and having a low moisture content, comprising the steps of:
retrieving a batch recipe associated with the nutritious snack mix composition;
retrieving ingredients associated with the batch recipe, the ingredients including at least one meat jerky, at least one dried fruit, and at least one nut product chosen from the group of: a raw nut, a sprouted nut, and a seed;
inspecting the retrieved ingredients for quality control purposes and removing any portion of the ingredients that are below a threshold quality level;
combining the at least one meat jerky, the at least one dried fruit, and the at least one nut product, in portions specified by the batch recipe, into a plurality of commercial product pouches, wherein the portions of the at least one jerky in each respective commercial product pouch are less than 40% of the total weight of the nutritious snack mix composition and wherein the combined portions of the at least one dried fruit and the at least one nut product in each respective commercial product pouch are at least 60% of the total weight of the nutritious snack mix composition;
inserting a moisture-absorbing sachet into each commercial product pouch;
removing excess air from each commercial product pouch; and
sealing each of the plurality of commercial product pouches.

2. The process of claim 1 wherein the step of inspecting the retrieved ingredients for quality control purposes includes inspecting packaging from which the ingredients are retrieved.

3. The process of claim 1 further comprising the step of removing the at least one meat jerky from an air-tight, interim package.

4. The process of claim 3 wherein the at least one meat jerky in the air-tight, interim package is pre-cut into diced-shaped pieces.

5. The process of claim 3 wherein the at least one meat jerky in the air-tight, interim package is in uncut form and further comprising the step of cutting the at least one meat jerky into diced-sized pieces.

6. The process of claim 3 wherein, after removing the at least one meat jerky from an air-tight, interim package, said at least one meat jerky is included in one of the plurality of sealed commercial product pouches within 12 hours from being removed from the air-tight, interim package.

7. The process of claim 1 wherein, before combining the at least one jerky, the at least one dried fruit, and the at least one nut product into a plurality of commercial product pouches, the at least one dried fruit and the at least one nut are combined and any clumps in said combination are broken up into smaller sizes.

8. The process of claim 1 wherein the step of sealing each of the plurality of commercial product pouches includes heat-sealing.

9. The process of claim 1 further comprising the step of inspecting the plurality of commercial product pouches for quality control purposes.

10. The process of claim 1 wherein the step of removing excess air from each commercial product pouch includes vacuum packing.

11. The process of claim 1 further comprising the step of code-dating each of the plurality of commercial product pouches.

12. The process of claim 1 wherein the at least one nut product includes one or more of almonds, macadamia, walnuts, pecans, pistachios, cashews, sunflower seeds, or pumpkin seeds.

13. The process of claim 1 wherein the at least one meat jerky includes one or more of the following types of meat: beef, pork, elk, venison, turkey, or ostrich.

14. The process of claim 1 wherein the at least one meat jerky is a low moisture jerky meat product.

15. The process of claim 1 wherein the at least one dried fruit includes one or more of the following types of fruit: raisins, cranberries, cherries, prunes, pineapples, apricots, apples, nectarines, or peaches.

16. The process of claim 1 further comprising the step of adding seasoning to each respective commercial product pouch.
